(19) United States
(12) Patent Application Publication
(10) Pub. No.: US 2024/0037617 A1
(43) Pub. Date: Feb. 1, 2024

(54) MERCHANT LISTING VERIFICATION SYSTEM

(71) Applicant: Yext, Inc., New York, NY (US)

(72) Inventors: Calvin Casalino, New York, NY (US); Patrick Huang, New York, NY (US); Alexander Daniels, Brooklyn, NY (US); Christopher Xi, Brooklyn, NY (US); Michael Misiewicz, Brooklyn, NY (US); Allison Rossetto, New York, NY (US); Michael Iannelli, Brooklyn, NY (US)

(21) Appl. No.: 17/876,295

(22) Filed: Jul. 28, 2022

(51) Int. Cl. G06Q 30/06

(52) U.S. Cl. CPC G06Q 30/0603

(57) ABSTRACT

A merchant listing verification system to scan a publisher system of a set of publisher systems to identify a published merchant listing published by the publisher system, where the published merchant listing includes a first set of data fields and a first set of data field values associated with a merchant system. The merchant listing verification system compares, on a field-by-field basis, the published merchant system to a target merchant listing comprising a second set of data fields and a second set of data field values associated with the merchant system. Based on the comparing, a discrepancy between a first data value of a first data field of the first set of data fields of the published merchant listing and a second data value of a second data field of the second set of data fields of the target merchant listing is identified.

### TECHNICAL FIELD

The disclosure relates generally to online information associated with a merchant system, and more particularly, to methods and systems for verifying merchant system information.

### BACKGROUND

Various online services are available to locate and find listings about certain merchants, businesses, and services. One of the challenges in providing merchant-related listings online across multiple different publisher systems (e.g., third-party websites and applications that publish the merchant data for consumption by end-users, such as Google™, Facebook™, etc.) is to maintain accuracy and consistency in the listing information published by those publisher systems. Mistakes in the listing may range in severity, from being low in severity to being high in severity where the error in the merchant or business listing may be critical information for the business, such as a street address, phone number, hours of operations and or other types of critical information related to the business. Accordingly, merchant systems require constant review and synchronization of the various instances of their business listings to identify and remedy cases where the publisher displays different data in error or from an inaccurate or out-of-date source.

### BRIEF DESCRIPTION OF THE DRAWINGS

The present disclosure is illustrated by way of example, and not by way of limitation, and can be more fully understood with reference to the following detailed description when considered in connection with the figures as described below.

FIG. 1 illustrates an example environment including a merchant listing verification system, in accordance with one or more aspects of the present disclosure.

FIG. 2 illustrates an example listing comparator of a merchant listing verification system, in accordance with one or more aspects of the present disclosure.

FIG. 3 illustrates an example listing comparator of a merchant listing verification system, in accordance with one or more aspects of the present disclosure.

FIG. 4 illustrates an example interface generated by a merchant listing verification system, in accordance with one or more aspects of the present disclosure.

FIG. 5 illustrates an example interface generated by a merchant listing verification system, in accordance with one or more aspects of the present disclosure.

FIG. 6 illustrates a flow diagram of an example merchant listing verification process, in accordance with one or more aspects of the present disclosure.

FIG. 7 illustrates an example computer system operating in accordance with one or more aspects of the present disclosure

### DETAILED DESCRIPTION

Managing the accuracy of the merchant listing data is critically important to the merchant in that there is direct impact in the ability for the merchant to effectively communicate with end-users (e.g., current or prospective customers). However, since many publisher systems may not be aware of errors corresponding to the thousands of business listings managed by the publisher system, identification of the data discrepancies can be a time-consuming process. In this regard, reviewing each merchant listing would take an inordinate amount of time by the publisher system or the merchant system, while still exposing the merchant system to the high degree of risk that the business listing contains incorrect information if, for example, there are updates, edits, or adjustments to the merchant data.

Aspects of the present application are related to a merchant-related listing verification system (herein the “verification system”) to scan multiple publisher systems to identify discrepancies in data associated with the merchant listing. The verification system employs rule-based logic and machine-learning processing to scan, identify and synchronize the merchant-related data listing (also referred to as a “merchant listing”) across the multiple different publisher platforms (e.g., Google, Facebook, Instagram, Youtube, etc.). According to embodiments, the verification system displays the identified discrepancies to the corresponding merchant system (also referred to as a “user system”). Advantageously, the verification system uses advanced scanning processing to proactively identify the listing discrepancies and employs rules-based logic, machine learning processing, or a combination thereof to perform a comparison of the identified published listing and a stored set of merchant listing data that is verified and approved by the merchant system (e.g., also referred to as a “target merchant listing record”).

According to embodiments, the third-party publisher systems that publish merchant listings may change the merchant information, even after the merchant listing data has been synchronized to the various different publisher systems. Advantageously, the verification system automatically scans the listings on those publisher sites (also referred to as a “published merchant listing) and compare the information found there with the information stored in the verification systems. In response to determining a discrepancy in one or more data elements (e.g., a data field and value) of the merchant listing, the verification system can automatically change the information and provide to the publisher system for publication of the updated and corrected merchant listing. In an embodiment, the verification system can, in response to identification of a discrepancy, provide the published version of the merchant listing to the merchant system as a “publisher suggestion” which the merchant system can approve or reject.

The verification system provides an efficient process for standardizing and synchronizing merchant listing data. The merchant listing managed by the verification system can include a set of different data fields and corresponding data values. Example data fields can include a name field (e.g., the name of the merchant), an address field, a phone number field, a business categories field, a website information field, etc. The verification system can maintain different types of comparison logic and adaptively apply one of the different comparison logic types based on which data field of the published merchant listing is being compared to the stored or target merchant listing. Accordingly, the type of comparison logic that is used (e.g., fuzzy logic, machine learning, etc.) is determined by the verification system based on the particular data field of the published merchant listing that is being compared to the stored or target merchant listing.

In an embodiment, the verification system determines a degree of difference between the data value or values of a data field of the published merchant listing and the verified data value or values of the same data field in the target merchant listing. Advantageously, the verification system can determine, based on the degree of difference, whether the difference in the merchant listing data is material. In an embodiment, the verification system can manage one or more rules for performing the comparison of the data fields of the published merchant listing and the target merchant listing.

In an embodiment, the verification system can generate and provision one or more interfaces to display information relating to the merchant's listings as published by the multiple publisher systems. In an embodiment, the interface can include configurable displays of the merchant listing information including highlights of one or more identified discrepancies between the published merchant listings and the target merchant listing. The interfaces enable the merchant system to provide feedback regarding the published merchant listings, including an acceptance or rejection of a published merchant listing. The listing verification system provides a centralized platform for a merchant system to manage their listing data as published across the multiple different publisher systems.

In the following description, numerous details are set forth. It will be apparent, however, to one skilled in the art, that the present disclosure may be practiced without these specific details. In some instances, well-known structures and devices are shown in block diagram form, rather than in detail, in order to avoid obscuring the present disclosure.

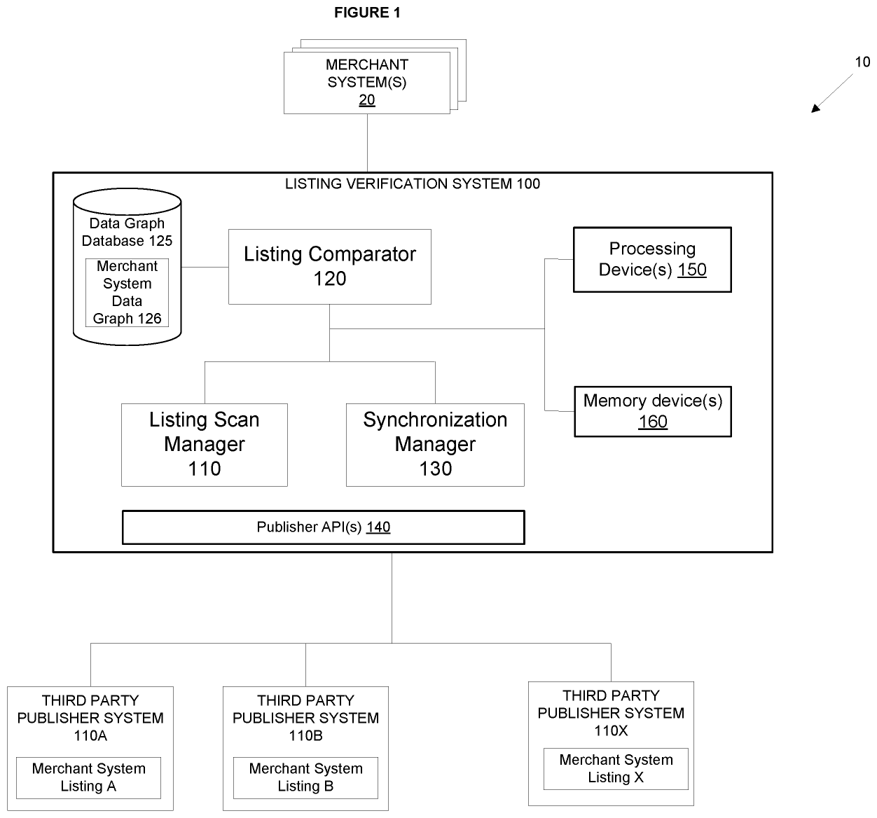

FIG. 1 illustrates an example of an environment 10 including a listing verification system 100 for managing merchant listings as published by a set of multiple different third-party publisher systems (e.g., third-party publisher system 110A, third-party publisher system 110B . . . third-party publisher system 110X, where X is any integer value), in accordance with one or more aspects of the disclosure. In an embodiment, the listing verification 100 includes one or more modules, one or more processing devices and one or more memory devices configured to execute and store instructions associated with the functionality of the various components, services, and modules of the listing verification system 100, as described in greater detail below in connection with FIGS. 1-7.

The listing verification system 100 is a computing system communicatively connected to one or more merchant systems 20 and the third-party publisher systems 110A, 110B, . . . 110X via a suitable communication network. In an embodiment, the listing verification system 100 may be accessible and executable on one or more separate computing devices (e.g., servers). In an embodiment, the listing verification system 100 may be communicatively coupled to the merchant system(s) 20 and third-party publisher systems 110 via any suitable interface or protocol, such as, for example, application programming interfaces (APIs), a web browser, JavaScript, etc. In an embodiment, the listing verification system 100 is communicatively coupled to a third-party publisher system 110 via a corresponding API, referred to as a publisher API 140. In an embodiment, communications between the listing verification system 100 and each third-party publisher system 110 can be managed by a dedicated API corresponding to each respective third-party publisher system 110. In an embodiment, the listing verification system 100 includes one or more memory devices 160 to store instructions executable by one or more processing devices 150 to perform the instructions to execute the operations, features, and functionality described in detail herein.

The term “computing system”, “computer” or “computer platform” is intended to include any data processing device, such as a desktop computer, a laptop computer, a tablet computer, a mainframe computer, a server, a handheld device, a digital signal processor (DSP), an embedded processor, or any other device able to process data. The computer/computer platform is configured to include one or more microprocessors communicatively connected to one or more non-transitory computer-readable media and one or more networks. The term “communicatively connected” is intended to include any type of connection, whether wired or wireless, in which data may be communicated. The term “communicatively connected” is intended to include, but not limited to, a connection between devices and/or programs within a single computer or between devices and/or separate computers over a network. The term “network” is intended to include, but not limited to, OTA (over-the-air transmission, ATSC, DVB-T), packet-switched networks (TCP/IP, e.g., the Internet), satellite (microwave, MPEG transport stream or IP), direct broadcast satellite, analog cable transmission systems (RF), and digital video transmission systems (ATSC, HD-SDI, HDMI, DVI, VGA), etc.

According to embodiments, the listing verification system 100 can access a publisher API 140 associated with a corresponding third-party publisher system 110 to perform scanning and synchronization operations relating to the merchant system listings published by those publisher systems (e.g., Google, Yelp, Facebook, Instagram, etc.). The merchant listing can include a set of data fields and values relating to merchant data (e.g., a business name, address, telephone number, a link to a website for the business, a pointer to a map of the location of the business, a merchant location on a map, a promotional message associated with the merchant, and a list of information regarding offerings of the merchant, etc.). Each of the publisher systems 110 may host a computer platform that provides a plurality of modules (e.g., APIs) with which the listing verification system 100 interacts for carrying out operations of the listing verification process.

According to embodiments, the listing verification system 100 can include one or more software and/or hardware modules to perform the operations, functions, and features described herein in detail, including a listing scan manager 110, a listing comparator 120, and a synchronization manager 130. In one embodiment, the components or modules of the document segmentation system 100 may be executed on one or more computer platforms that are interconnected by one or more networks, which may include a wide area network, wireless local area network, a local area network, the Internet, etc. The components or modules of the document segmentation system 100 may be, for example, a hardware component, circuitry, dedicated logic, programmable logic, microcode, etc., that may be implemented in the processing device(s) 150 to execute instructions stored in the one or more memory devices 160 of the listing verification system 100.

In an embodiment, the listing verification system 100 can include a data graph database 125 including a merchant system data graph 126 for each merchant system 20. For example, the listing verification system 100 can maintain a first merchant system data graph for a first merchant system, a second merchant system data graph for a second system, and so on. Each data graph or knowledge graph (e.g., merchant system data graph 126) associated with the merchant system can include data associated with a target merchant listing. The target merchant listing can include a set of data fields and corresponding values that represent the verified listing data for the merchant system 20. In an embodiment, the knowledge graph 105 (also referred to as a “data graph”, “user data graph” or a “user knowledge graph”) includes elements of the target merchant listing that are indexed and searchable to identify data corresponding to the target merchant listing for use in comparing with the identified published merchant listings during the comparison phase, described in detail below. In an embodiment, the knowledge graph 126 corresponding to a particular merchant system 20 can be generated, managed, and updated in the data graph database 125 to establish the verified or target merchant listing based on information that is approved, confirmed, updated, and verified by the merchant system.

According to embodiments, the listing verification system 100 initiates a scanning process to scan the set of third-party publisher systems 110 to identify a published listing associated with a merchant system as published by the respective publisher systems 110. The identified merchant listings are collected and compared to a target or verified merchant listing to generate a comparison result. Advantageously, the verification process results can be used to identify individual data discrepancies to assist merchant systems in remedying the published listing data and provide for uniformity and accuracy in the merchant listing data as it is published to end-users via the multiple different publisher systems.

In an embodiment, the collected third-party merchant listings and the comparison results are presented for display to the merchant system via a listings detail interface. The listings detail interface can include information identifying each third party publisher system and published merchant listing identified during the scanning process. The listings detail page may further present one or more indications associated with discrepancies between the identified published merchant listings and the target merchant listings. In an embodiment, each indication of a discrepancy can be highlighted and presented to the merchant system with a selectable option corresponding to an action (e.g., accept the published version and discrepancy or reject the published version and the discrepancy). According to embodiments, the results of the verification process associated with a merchant listing can be used for analytic purposes, where the verification process statistics are aggregated and analyzed for provisioning to the merchant system and used by the listing verification system 100 to improve integrations with the various publisher systems.

According to embodiments, the verification process executed by the listings verification system 100 can be initiated on a periodic basis in accordance with a selected frequency (e.g., hourly, daily, weekly, monthly, etc.), in response to a merchant system action associated with the merchant listing (e.g., the addition of a new location associated with the merchant, an update to the merchant listing data by the merchant system), or in response to a verification action (e.g., a request from the merchant system to execute the verification process).

In an embodiment, the listing scan manager 110 is configured to execute and manage the scanning process to scan the set of multiple publisher systems and identify the corresponding published merchant listing. The listing scan manager 110 can initiate communications with the set of publisher systems to identify and collect information relating to the respective merchant listings as published (e.g., at the time of the scan) by the respective publisher systems. In an embodiment, the listing scan manager 110 can enable visibility by the merchant system 20 into the scanning process by enabling the merchant system to view details concerning the scanning operation. For example, the listing scan manager 110 can track statistics regarding successful scan operations and failed scan operations (e.g., scans that get “stuck” and fail to produce a listing capture) to enable changes to correct any scanning issues.

According to embodiments, a scan operation of the verification process can be performed to verify that previously distributed updates relating to the merchant listing (e.g., corrections or updates relating to a discrepancy in the merchant listing, new or updated data relating to the merchant listing etc.) have been processed and published by the corresponding publisher system. According to embodiments, the multiple publisher systems can be prioritized or otherwise classified into tiers, such that the scan frequency can be set as a function of the publisher tier. For example, a tier 1 publisher may be automatically scanned at a first frequency (e.g., weekly), a tier 2 publisher may be automatically scanned at a second frequency (e.g., monthly), and so on.

According to embodiments, the listing scan manager 110 can record metrics relating to any failed scan attempts. The metrics can be sorted and categorized by publisher system and task type to enable specific alerting communications and narrow investigation efforts to determine the root cause of the scanning issue. In an embodiment, the listing scan manager 110 manages a metric that maintains a count of all forms of task failures labeled with a respective publisher system identifier (e.g., a unique identifier associated with a publisher system), and a failure type (e.g., validation failure, internal failure, external failure, a timeout failure, etc.). The listing scan manager 110 can execute an alerting process to generate and send alerts to appropriate users of the listing verification system 100 regarding the identified scan failure.

In an embodiment, the listing scan manager 110 is configured to identify “stuck” scans and perform a process to “unstick” or advance and complete those scans. For example, a scan may be stuck or unable to complete due to task type dependencies. In another example, a particular scan task may not complete during a specified period of time. The listing scan manager 110 can identify incomplete tasks that have not progressed through the pipeline in a set period of time (e.g., 12 hours) and determine why those tasks have not completed in the allotted time period. In an embodiment, the listing scan manager 110 can perform a scheduled monitoring task that periodically queries the tasks table for rows with a non-terminal status and a processing time that is more than the prescribed time (e.g., more than 12 hours).

The listing scan manager 110 can further diagnose and determine the reason or cause of the incomplete scan operation. In an embodiment, the listing scan manager 110 employs a diagnostic endpoint that returns stuck task identifiers, paired with publisher ID, task type, and a corresponding reason for the incomplete status of the scan task. The diagnostic endpoint perform a query to pull all stuck tasks, then compares against the contents of a scan task scheduler queue to determine the stuck reason for each of these tasks. For example, the incomplete scan task could be blocked (e.g., the reason the scan is incomplete is because it is blocked). In another example, the incomplete scan task could be “not queued” (e.g., the reason the scan is incomplete is because it is not queued). In another embodiment, the listing scan manager 110 can identify the cause of the incomplete scan task as being due to insufficient resources. To identify an ‘insufficient resources’ cause type, the listing scan manager 110 builds and maintains a mapping of resource constrained tasks. In an embodiment, tasks can be added to this map within a function configured to identify the runnable tasks, following a “break” as a result of a number of available units being exhausted. Once the endpoint is built, the listing scan manager 110 can call the endpoint from a task (e.g., a fixed interval task) that results in the recordation of the values.

In an embodiment, the listing comparator 120 executes a comparison operation to compare the one or more published merchant listings identified during the scan operation to the stored target merchant listing. In an embodiment, the listing comparator 120 retrieves the target merchant listing from the merchant system data graph 126 associated with the particular merchant system 20. In an embodiment, the target merchant listing can be updated and stored in the merchant system data graph 126 associated with the merchant.

According to embodiments, the listing comparator 120 includes comparison logic executable on a field-by-field basis with respect to the merchant listing. The listing comparator 120 executes the comparison logic to compare each individual data field and value of the target merchant listing with a corresponding data field and value of the published merchant listing. For example, the listing comparator 120 performs a field-by-field comparison of the following data fields of the merchant listing: address, city, hours of operation, open or closed status, merchant name, phone number(s), postal code, URLs, geographic information, categories of the merchant's business, etc.

In an embodiment, the listing comparator 120 identifies a listing pair corresponding to the target merchant listing (e.g., the merchant listing as verified, approved, and stored in the merchant system data graph 126) and a published merchant listing (herein referred to as a “listing pair”). In an embodiment, for each data field of the listing pair, the listing comparator 120 performs an alignment sub-operation to align the format and structure of each data field of the listing pair. For example, for a structured field, the listing comparator 120 performs a string match comparison. In another example, for an unstructured field (e.g., the address field, the merchant name field, etc.), the listing comparator 120 executes a fuzzy match scoring process including the execution of a fuzzy match algorithm to score each match and use a score threshold.

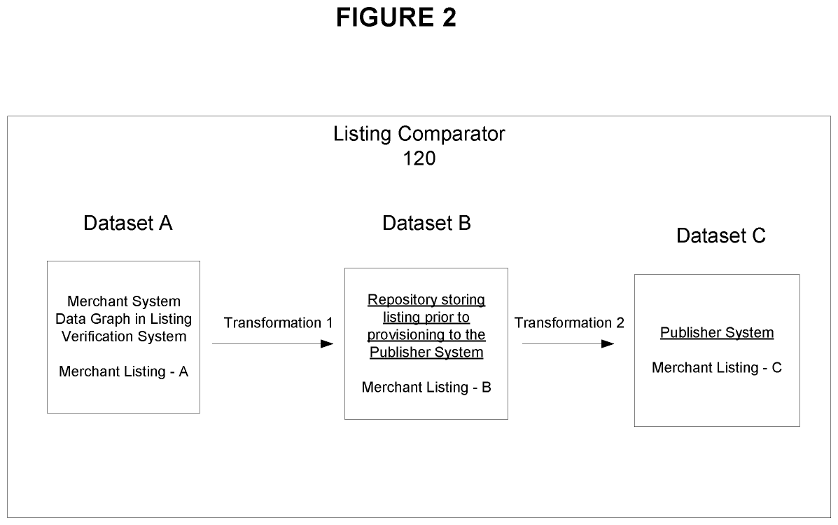

In an embodiment, the listing comparator 120 use the fuzzy match logic to determine if two unstructured fields are a match using a comparison score threshold to classify the pair. In an embodiment, the score threshold corresponding to each classification is generated using sets of training data. FIG. 2 illustrates an example process relating to the comparison function executed by the listing comparator 120. As shown in FIG. 2, in a first stage, a first dataset (Dataset A) including the data fields of the merchant listing as stored in the data graph of the listing verification system 100 is compared to a second dataset (Dataset B) including data fields of the merchant listing as stored in a repository prior to “pushing” or sending to the publisher system. Since the data in the Dataset A is known and the data in Dataset B is known prior to sending the publisher system, the listing comparator 120 determines that Dataset A and Dataset B are a match. In a second stage, Dataset A is compared to Dataset C, which includes the merchant listing as published on the publisher system (e.g., the merchant listing of the publisher system that is determined during the scanning phase). In an embodiment, in this comparison, an auditing of the datasets is performed to determine if the data matches or not.

As shown in FIG. 2, the listing comparator transforms or edits the data in Dataset B based on the listing in Dataset A (e.g., the data in the knowledge graph). This transformation (transform 1) is performed to match the expected publisher system guidelines based on the publisher system's API documentation. In an embodiment, transform 2 involves publisher system edits to displayed data as compared to what is delivered to the publisher system. IN an embodiment, a publisher system may perform this transformation (transform 2) if the publisher system has a particular format or preference regarding the data display of the publisher system.

In an embodiment, the listing comparator 120 applies a set of cleaning rules and executes fuzzy match scoring to the labeled datasets using a selected threshold that maximizes at least a portion of the metrics for each unstructured field. Example thresholds can include an F1 score, a precision threshold (e.g., to reduce false positives), or a recall threshold (e.g., to reduce false negatives). Advantageously, as shown in the following examples, the listing comparator 120 performs a field-by-field comparison with a set of rules selected based on the type of field. Example field types include the “address” field, the “name” field, the “closed status” field, the “hours” field, the “name” field, the “phone number” field, the “postal codes” field, the “URL” field, the “export display latitude and longitude” field, etc.

In an example, in comparing the “address” field of the datasets (e.g., e.g., the address field of Dataset A and the address field of Dataset C), the listing comparator 120 can execute cleaning or normalizing operation(s) including one or more of normalizing uppercase and lowercase characters (e.g., treating a lowercase “b” the same as an uppercase “B”) , replacing diacritic characters with a corresponding universal letter (e.g., characters “ÁĂÁ̆ [symbol] À̆ [symbol] Ã̆\check{A}Â\hat{Á} [symbol] \hat{À} [symbol] \hat{Ã}Ä\ddot{Ā}\dot{A}\dot{Ā} [symbol] Ā [symbol] Å\acute{Å} [symbol] Ã [symbol] ” are replaced with “A”), replacing street suffixes with a corresponding abbreviation, and removing characters that are not either letters or digits. In an embodiment, following the cleaning operation, the listing comparator 120 executes a fuzzy match scoring process and classifies the field as a “match” or “no match” based on the applied threshold (e.g., F1 scores, precision, or recall thresholds).

In another example, in comparing the “city” field of the datasets (e.g., the city field of Dataset A and the city field of Dataset C), the listing comparator 120 can clean the fields by normalizing uppercase and lowercase characters, replacing diacritic characters with a corresponding universal letter, and removing characters that are not letters. The listing comparator 120 classifies the field as a “match” or “no match” based on a string match comparison.

In another example, in comparing the “closed status” field of the datasets (e.g., the closed status field of Dataset A and the closed status field of Dataset C), the listing comparator 120 classifies the field as a “match” or “no match” based on a string match comparison and determines, for example, if the status is “temporarily closed” or “permanently closed”.

In another example, in comparing the “hours” field of the datasets (e.g., the hours field of Dataset A and the hours field of Dataset C), the listing comparator 120 can clean the fields by replacing a hyphen (“-”) with “to” (e.g., “9:00 AM-6:00 PM” is normalized to “9:00 AM to 6:00 PM”). The listing comparator 120 classifies the field as a “match” (e.g., if all days of the week are a “match”) or “no match” based on a string match comparison.

In another example, in comparing the “name” field of the datasets (e.g., the name field of Dataset A and the name field of Dataset C), the listing comparator 120 can execute the cleaning or normalizing operation(s) including replacing/comparing uppercase letters, replacing diacritic characters with a corresponding universal letter, removing occurrences of certain phrases including “the”, “and”, “of”, “at”, “in”, etc.), and removing characters that are not letters or digits. In an embodiment, following the cleaning operation, the listing comparator 120 executes a fuzzy match scoring process and classifies the field as a “match” or “no match” based on a selected threshold.

In another example, in comparing the “phone number” field of the datasets (e.g., the phone number field of Dataset A and the phone number field of Dataset C), the listing comparator 120 can clean the fields by removing non-digit characters (e.g., country calling codes including “+”, area codes including parentheses, hyphens, etc.) and removing leading, trailing and/or in-between whitespace. The listing comparator 120 classifies the field as a “match” or “no match” based on a string match comparison.

In another example, in comparing the “postal codes” field of the datasets (e.g., the postal code field of Dataset A and the postal code field of Dataset C), the listing comparator 120 classifies the field as a “match” or “no match” based on a string match comparison.

In another example, in comparing the “URL” field of the datasets (e.g., the URL field of Dataset A and the URL field of Dataset C), the listing comparator 120 replaces “https” with “http” and classifies the field as a “match” or “no match” based on a string match comparison.

In another example, in comparing the “latitude/longitude (Lat/Lng)” field of the datasets (e.g., the Lat/Lng field of Dataset A and the Lat/Lng field of Dataset C), the listing comparator 120 removes cardinal directions and convert latitude and longitude coordinates accordingly (e.g., “N” is +, “S” is −), removes non-digit characters (e.g., degrees symbol “°”), and round latitude and longitude digits to 4 decimal places (e.g., representing accuracy up to ˜11 meters). The listing comparator 120 then classifies the latitude portion of the field as a “match” or “no match” and the longitude portion of the field as a “match” or “no match”.

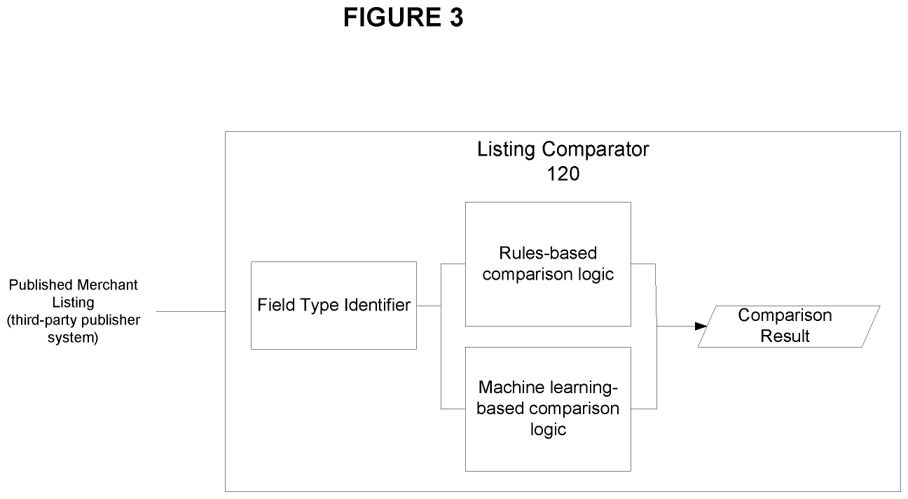

FIG. 3 illustrates an example listing comparator 120, according to embodiments of the present disclosure. As illustrated, the listing comparator 120 identifies a published merchant listing from a publisher system (e.g., identified during the scanning process) and compares the published listing with the stored or target merchant listing (e.g., the merchant listing stored in the data graph associated with the merchant system). The listing comparator 120 identifies each field (e.g., a field type) of the set of fields of the published merchant listing. According to embodiments, the listing comparator 120 executes comparison logic (e.g., rules-based comparison logic or machine learning-based comparison logic (also referred to as a “statistical verifier”)) to produce a comparison result (e.g., a verification result).

In an embodiment, the listing comparator 120 compares two strings (e.g., a field in Dataset A and the corresponding field in Dataset C) by cleaning and tokenizing the strings and calculating token-level probabilities to generate a single probability score that describes the likelihood of one string transforming into the other. In an embodiment, the listing comparator 120 use a Levenshtein distance dynamic programming function to generate priors used to calculate Bayesian probability to describe the likelihood of a string transformation. The comparison process advantageously takes two strings and finds the probability of one transforming into the other. In an embodiment, the comparison process is used to verify whether the merchant listing field values of the stored merchant listing (Dataset A) matches the respective publisher system versions. According to embodiments, the listings delivery pipeline (e.g., the processing of Dataset B) can adjust the knowledge graph data (e.g., the stored or target merchant listing) for provisioning to the publisher system (e.g., formatting changes). In an embodiment, the publisher system can provide feedback relating to changes to the data before displaying the data on the publisher system web site(s).

According to embodiments, the listing comparator 120 takes all token-level edit data using Levenshtein distance and computes a Bayesian probability to produce one or more stable and accurate edit prediction relating to the comparison of the pair of unstructured string fields (e.g., field type X of the target merchant listing and Field type X of the published merchant listing).

In an embodiment, the listing comparator 120 executes the machine learning-based comparison logic to execute a first operation including creating a baseline merchant listing field value dataset including all the information used during the field data comparison. For example, the baseline merchant listing field value dataset can include administrative data (e.g., a publisher identifier, a merchant identifier, one or more listing identifiers, a verifier prediction generated using rules-based logic), and the data to be analyzed (e.g., the target merchant listing and published merchant listing field values, such as the “name” field values, the “address” field values, etc.).

In an embodiment, the listing comparator 120 can collect baseline data (e.g., gather the data that makes up the baseline dataset) from a data warehouse (e.g., a Snowflake data warehouse). In a second operation, the collected baseline data (also referred to as the “baseline dataset”) can be cleaned and prepared for analysis to clean and apply transformations to the raw data in the baseline dataset. For example, the listing comparator 120 can apply HTML decoding and tokenization to the field data (e.g., the “name” or “address” field). In an embodiment, this process can include applying HTML decoding (e.g., some of the warehoused field data may contain raw HTML), tokenize the field strings (e.g., using a tokenizer on the cleaned field value strings to get the individual tokens, and remove blank rows from the dataset (e.g., after tokenization, some of the field values may be blank (e.g. a field value containing “;”) and the blank field values are removed from the dataset) to generate a cleaned and tokenized dataset.

In an embodiment, in a third operation, using the cleaned and tokenized dataset, the listing comparator 120 classifies token-level edits for all token data points in the dataset. This includes comparing two token strings, S1 and S2, pairwise and for each token pair (S1[T0], S2[T0]) . . . (S1[Tn], S2[Tn]) and determine whether there was a token deletion, insertion, or swap. For example, the listing comparator 120 compares the tokenized target merchant listing and the published merchant listing field strings (S1, S2) at a token-level, and uses a Levenshtein distance dynamic programming function to calculate the token-level insertions, deletions and swaps. The purpose of this function is to find and return the optimum path taken to transform the previous word using Levenshtein edit distance. The output of the function is a list of tuples containing token pairs consisting of step (edit) type, and the token corresponding to target merchant listing and the token corresponding to the published merchant listing. In an example, for [“123”, “Street”] and [“123”, “St”], the listing comparator 120 generates a comparison result of [(‘no_change’, (‘123’, ‘123)), (‘swap’, (‘Street’, ‘St’))].

In an embodiment, the listing comparator 120 creates a matrix of the two tokenized strings. Then, the listing comparator 120 iterates through every element of the matrix and checks to determine if the two elements (e.g., tokens) are the same. If, for example, the two elements are the same, there is no change and the returned comparison result is (‘no_change’, (‘token1’, ‘token2’)).

In an embodiment, in a fourth operation, the listing comparator 120 calculates prior values for all token data points in the dataset. In an embodiment, for each data point to verify, the listing comparator 120 calculates all the prior probabilities for token-level edits, for each edit type identified in the previous step (e.g., insertion, deletion, or swap). The calculated prior values may be used to calculate one or more probabilities (e.g., a probability of deleting a particular token (also referred to as a “delete probability”), a probability of inserting a particular token (also referred to as an “insert probability”), or a probability of swapping two tokens (also referred to a “swap probability”).

According to an embodiment, during the fourth operation, for each token edit, the listing comparator 120 determines if a deletion occurs, an insertion occurs, or a swap occurs. If a deletion occurs, the listing comparator 120 calculate the probability of that token being deleted according to the following example expression:

P(Delete)=Σ(Token Deletions)/Σ(All Deleted Tokens)

In an embodiment, if there is no record of that token being deleted, the listing comparator 120 return a very low value to signify improbability using 1/length of the token.

In an embodiment, if an insertion occurs, the listing comparator 120 calculates the probability of that token being inserted according to the following example expression:

P(Insert)=Σ(Token Insertions)/Σ(All Inserted Tokens)

In an embodiment, if there is no record of that token being inserted, the listing comparator 120 returns a very low value to signify improbability using 1/length of the token.

In an embodiment, if a swap occurs, the listing comparator 120 calculates the probability of that token being swapped according to the following example expression:

$$P ( Swap ) = \frac{Σ ( Swapped Token Pair Occurrences )}{Σ ( All Swapped Token Pairs )}$$

If there is no record of that swapped token pair, the listing comparator 120 returns a very low value to signify improbability using Levenshtein distance.

In an embodiment, the aforementioned probability calculated by the listing comparator can be added to a data structure (e.g., a data table). The probability calculation process is repeated by the listing comparator 120 for every datapoint (e.g., row) to be verified.

As a result of the above operations, each datapoint to verify contains token-level edits sorted by deletions, insertions, and swaps. In a fifth operation, the listing comparator 120 calculates transition probabilities for each data point (row) to verify.

The listing comparator 120 may combine the token-level priors calculated in the previous step to calculate the Bayesian probability of an observed transformation from the original target merchant listing field string (S1) to the published merchant listing field string (S2). In an embodiment, the probability is a floating point value between 0 and 1, having a default (starting) probability value of 1. In an embodiment, the listing comparator 120 may execute the following logic to generate the probability of the transformation:

$$P ( A \vert B ) = \frac{P ( B \vert A ) \cdot P ( A )}{P ( B )}$$

where P(A|B) is the probability of the target listing token becoming the published listing token; and where P(B|A) is the probability of observing the transitions from the published listing token to the target listing token; and where P(A) is the probability of observing the specific target listing token relative to all target listing tokens; and where P(B) is the probability of observing the specific published listing token relative to all published listing tokens associated with a publisher system.

In an embodiment, the first part of the above numerator (P(A)) may be calculated, for each token in the token string, according to the following expressions:
If P(B|A) is a token deletion, then multiply the probability by the token's deletion probability;
if P(B|A) is a token insertion, then multiply the probability by the token's insertion probability; or
if P(B|A) is a token swap, then multiply the probability by the token pair swap probability

In an embodiment, the second part of the numerator (P(A)) represents a probability of observing the token relative to all target listing tokens. If the probability remains 1 (e.g., meaning the strings are identical), the probability is returned. Otherwise (e.g., if the probability is not 1), the listing comparator 120 calculates a sum of the target merchant token probabilities to determine P(A).

In an embodiment, the listing comparator 120 calculates the above denominator (P(B)) representing the probability of observing the token relative to all published tokens. In an embodiment, P(B) is calculated by summing all of the published token probabilities associated with a publisher system.

In an embodiment, with reference to the above expression, the numerator is divided by the denominator to determine the Bayesian probability of the target listing token string transforming into the published token string, then add it to the dataset, and the probability is added to the dataset. The above-described process is repeated for each data point that is to be verified.

With reference to FIG. 1, the synchronization manager 130 is configured to synchronize the verified listing data to the respective third party publisher systems 110A-110X. In an embodiment, the synchronization manager 130 can distribute or provision a set of listing data that has been verified, on a field-by-field basis, by the listing comparator 120 to a particular publisher system (e.g., the publisher system associated with the published listing data that was compared to the target listing data), according to the processes described above. In an embodiment, the synchronization manager 130 may also distribute data corresponding to an updated target merchant listing to multiple third party publisher systems 110. For example, in response to a merchant updating one or more field values, adding a new field and field value, etc., the synchronization manger 130 can send the merchant listing data to the publisher systems to enable the publisher systems to update their respective listings associated with that merchant. According to embodiments, the synchronization manager 130 can utilize the publisher APIs 140 to communicate with the respective publisher systems in provisioning the listing synchronization data.

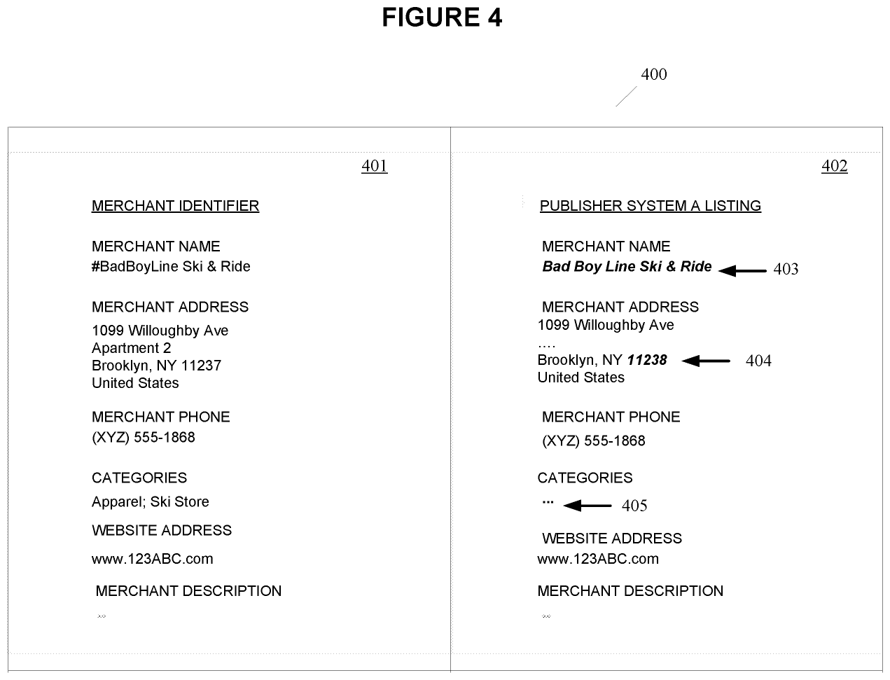

According to embodiments, the listing verification system 100 can generate one or more interfaces for display to the merchant system to display the verification processing results. For example, the listing verification system 100 can generate a summary of a comparison of a target listing data and a publisher system's published listing data. For example, FIG. 4 illustrates an example interface 400 generated by the listing verification system 100. As shown, the generated interface 400 includes a first portion 401 including data of a target listing associated with a merchant (e.g., #BadBoyLine Ski & Ride). The interface 400 includes a second portion 402 including data of a listing of the merchant as it is published by a publisher system (e.g., Publisher System A). In an embodiment, the interface 400 includes indications 403, 404, and 405 of discrepancies (e.g., a merchant name discrepancy 403, a zip code discrepancy 404, and a categories discrepancy 405) between the target merchant listing data (displayed in portion 401) and the publisher system A merchant listing data (displayed in portion 402) as identified by the listing verification system 100.

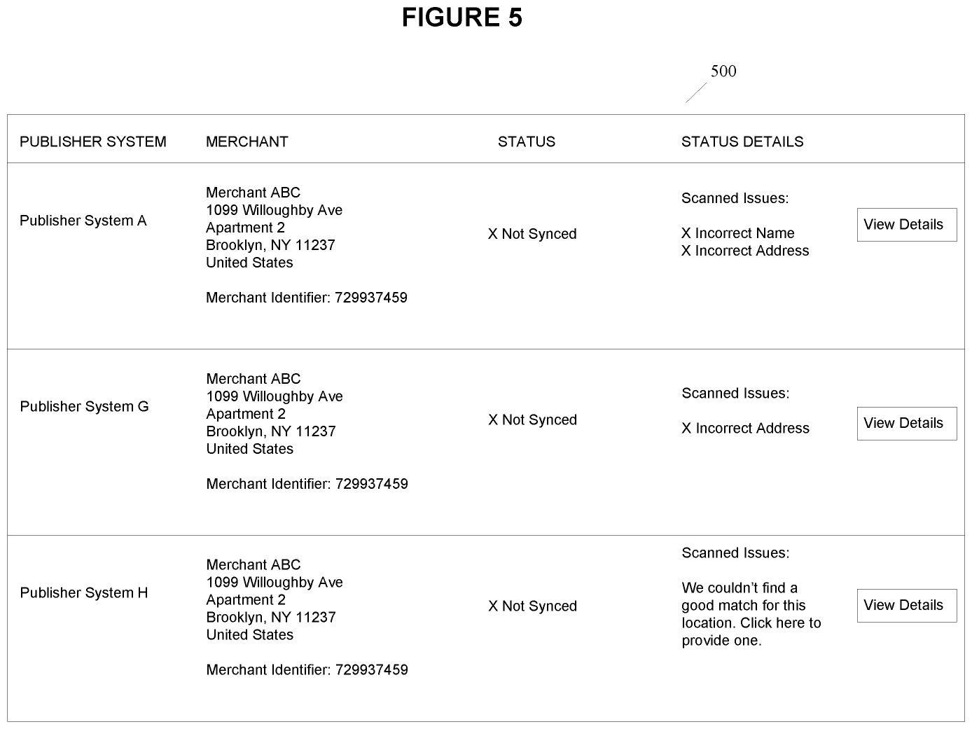

In an embodiment, the listing verification system 100 can generate an interface 500 or dashboard for display to a merchant system. The interface 500 can include information associated with the verification of the merchant listing with respect to one or more publisher systems. As shown in FIG. 5, the interface 500 displays different publisher systems (e.g., publisher system A, publisher system G, and publisher system H) and a synchronization status relating to the merchant listing. In the example shown, the interface 500 provides the merchant system with information showing synchronization issues (e.g., a not synced status) along with the one or more particular fields in which a discrepancy was identified by the listing verification system 100. For example, interface 500 illustrates that for merchant system ABC, publisher system A is not synced and includes an identified issue with respect to the name and address fields. The interface 500 further illustrates that publisher system G is not synced and includes an identified issue with respect to the address field. The interface further illustrates that publisher system H is not synced and the listing verification system 100 could not identify a matching listing associate with publisher system H for a location of the merchant.

Advantageously, the listing verification system 100 can generate interfaces 500 which present to the merchant system a set of information relating to the verification processing results. The interface 500 further enables the merchant system to view details concerning the identified discrepancies relating to the merchant listing and to take appropriate action with respect to each of the identified discrepancies or synchronizing issues.

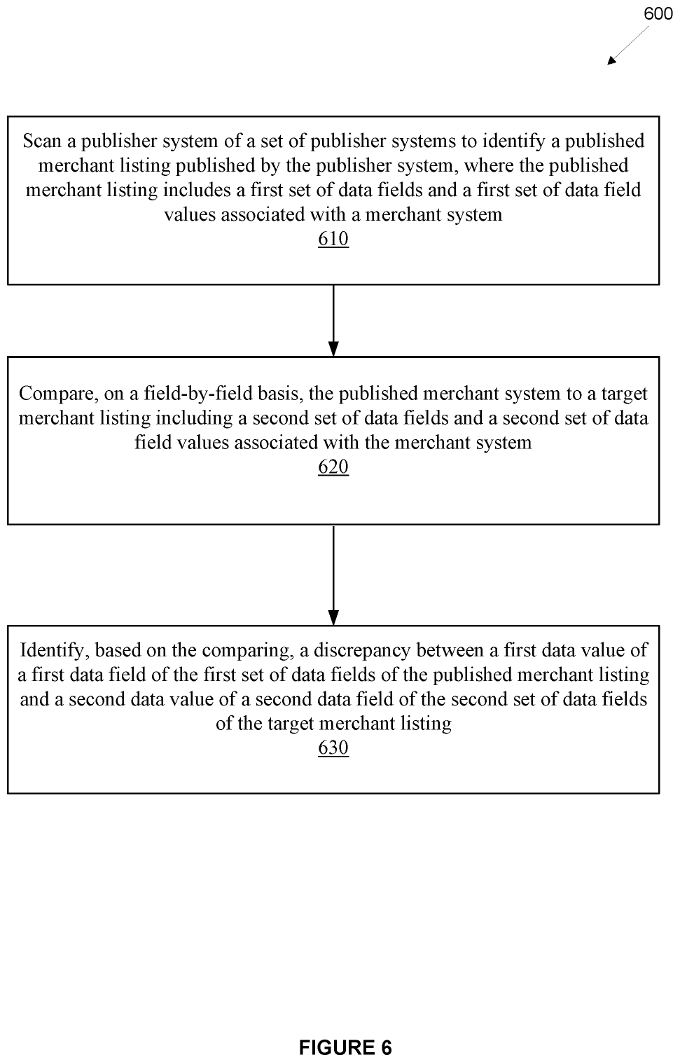

FIG. 6 illustrates a flow diagram relating to an example method 600 including operations performed by a listing verification system (e.g., listing verification system 100 of FIG. 1), according to embodiments of the present disclosure. It is to be understood that the flowchart of FIG. 6 provides an example of the many different types of functional arrangements that may be employed to implement operations and functions performed by one or more modules of the graph merge system as described herein. Method 600 may be performed by a processing logic that may comprise hardware (e.g., circuitry, dedicated logic, programmable logic, microcode, etc.), software (e.g., instructions run on a processing device), or a combination thereof. In one embodiment, processing logic of the listing verification system executes the method 600 to generate a comparison result associated with a merchant listing as published by a publisher system.

In operation 610, the processing logic scans a publisher system of a set of publisher systems to identify a published merchant listing associated with the publisher system. In operation 620, the processing logic compares, on a field-by-field basis, the published merchant system to a target merchant listing including a second set of data fields and a second set of data field values associated with the merchant system. In operation 630, the processing logic identifies, based on the comparing, a discrepancy between a first data value of a first data field of the first set of data fields of the published merchant listing and a second data value of a second data field of the second set of data fields of the target merchant listing.

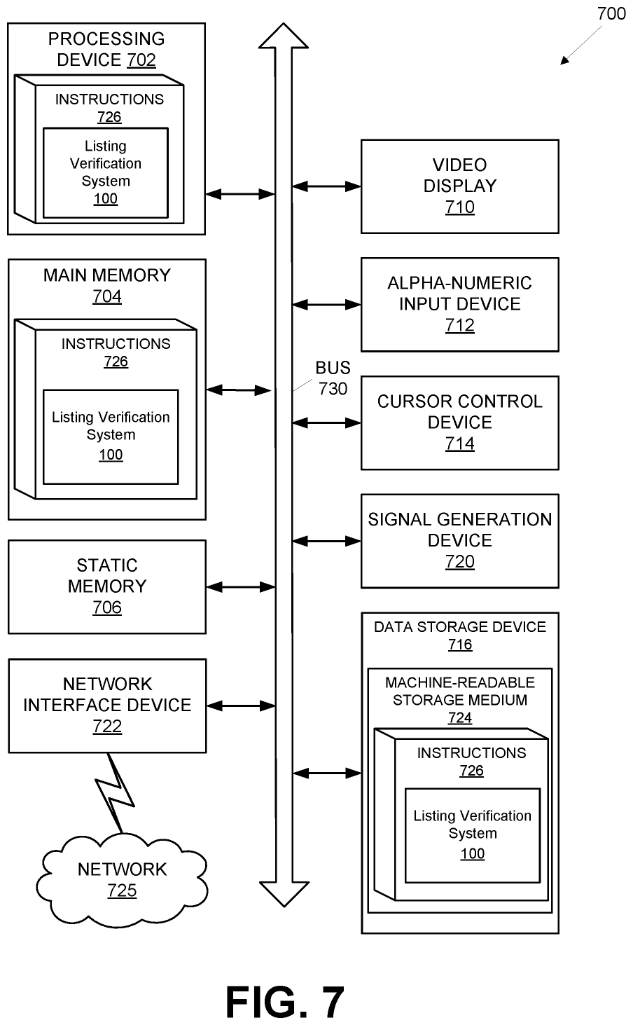

FIG. 7 illustrates an example computer system 700 operating in accordance with some embodiments of the disclosure. In FIG. 7, a diagrammatic representation of a machine is shown in the exemplary form of the computer system 700 within which a set of instructions, for causing the machine to perform any one or more of the methodologies discussed herein, may be executed. In alternative embodiments, the machine 700 may be connected (e.g., networked) to other machines in a local area network (LAN), an intranet, an extranet, or the Internet. The machine 700 may operate in the capacity of a server or a client machine in a client-server network environment, or as a peer machine in a peer-to-peer (or distributed) network environment. The machine may be a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that machine 700. Further, while only a single machine is illustrated, the term “machine” shall also be taken to include any collection of machines that individually or jointly execute a set (or multiple sets) of instructions to perform any one or more of the methodologies discussed herein.

The example computer system 700 may comprise a processing device 702 (also referred to as a processor or CPU), a main memory 704 (e.g., read-only memory (ROM), flash memory, dynamic random access memory (DRAM) such as synchronous DRAM (SDRAM), etc.), a static memory 706 (e.g., flash memory, static random access memory (SRAM), etc.), and a secondary memory (e.g., a data storage device 716), which may communicate with each other via a bus 730.

Processing device 702 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. Processing device 702 is configured to execute a document segmentation system 100 for performing the operations and steps discussed herein. For example, the processing device 702 may be configured to execute instructions implementing the processes and methods described herein, for supporting a document segmentation system 100, in accordance with one or more aspects of the disclosure.

Example computer system 700 may further comprise a network interface device 722 that may be communicatively coupled to a network 725. Example computer system 700 may further comprise a video display 710 (e.g., a liquid crystal display (LCD), a touch screen, or a cathode ray tube (CRT)), an alphanumeric input device 712 (e.g., a keyboard), a cursor control device 714 (e.g., a mouse), and a signal generation device 720 (e.g., a speaker).

Data storage device 716 may include a computer-readable storage medium (or more specifically a non-transitory computer-readable storage medium) 724 on which is stored one or more sets of executable instructions 726. In accordance with one or more aspects of the disclosure, executable instructions 726 may comprise executable instructions encoding various functions of the listing verification system 100 in accordance with one or more aspects of the disclosure.

Executable instructions 726 may also reside, completely or at least partially, within main memory 704 and/or within processing device 702 during execution thereof by example computer system 700, main memory 704 and processing device 702 also constituting computer-readable storage media. Executable instructions 726 may further be transmitted or received over a network via network interface device 722.

While computer-readable storage medium 724 is shown as a single medium, the term “computer-readable storage medium” should be taken to include a single medium or multiple media. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “scanning”, “comparing”, “identifying,” “determining,” “causing,” “using,” “receiving,” “presenting,” “generating,” “deriving,” “providing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the disclosure also relate to an apparatus for performing the methods described herein. This apparatus may be specially constructed for the required purposes, or it may be a general-purpose computer system selectively programmed by a computer program stored in the computer system. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear as set forth in the description below. In addition, the scope of the disclosure is not limited to any particular programming language. It will be appreciated that a variety of programming languages may be used to implement the teachings of the disclosure.

It is to be understood that the above description is intended to be illustrative, and not restrictive. Many other embodiment examples will be apparent to those of skill in the art upon reading and understanding the above description. Although the disclosure describes specific examples, it will be recognized that the systems and methods of the disclosure are not limited to the examples described herein, but may be practiced with modifications within the scope of the appended claims. Accordingly, the specification and drawings are to be regarded in an illustrative sense rather than a restrictive sense.

What is claimed is:

1. A method comprising:
scanning, by a processing device, a publisher system of a set of publisher systems to identify a published merchant listing associated with the publisher system, wherein the published merchant listing comprises a first set of data fields and a first set of data field values associated with a merchant system;
comparing, on a field-by-field basis, the published merchant system to a target merchant listing comprising a second set of data fields and a second set of data field values associated with the merchant system; and
identifying, based on the comparing, a discrepancy between a first data value of a first data field of the first set of data fields of the published merchant listing and a second data value of a second data field of the second set of data fields of the target merchant listing.

2. The method of claim 1, further comprising causing generation of a graphical user interface comprising an indication of the discrepancy.

3. The method of claim 1, wherein the comparing is performed according to a set of comparison rules.

4. The method of claim 3, wherein the set of comparison rules comprises a first rule associated with a first field type of the target merchant listing and a second field type of the target merchant listing.

5. The method of claim 4, further comprising identifying the first data field of the first set of data fields of the published merchant listing is the first field type.

6. The method of claim 5, wherein the first data field of the published merchant listing is compared to the second data field of the target merchant listing in accordance with the first rule.

7. The method of claim 1, wherein the comparing is performed according to a machine learning process.

8. A system comprising:
a memory to store instructions; and
a processing device, operatively coupled to the memory, to execute the instructions to perform operations comprising:
scanning, by a processing device, a publisher system of a set of publisher systems to identify a published merchant listing associated with the publisher system, wherein the published merchant listing comprises a first set of data fields and a first set of data field values associated with a merchant system;
comparing, on a field-by-field basis, the published merchant system to a target merchant listing comprising a second set of data fields and a second set of data field values associated with the merchant system; and
identifying, based on the comparing, a discrepancy between a first data value of a first data field of the first set of data fields of the published merchant listing and a second data value of a second data field of the second set of data fields of the target merchant listing.

9. The system of claim 8, the operations further comprising causing generation of a graphical user interface comprising an indication of the discrepancy.

10. The system of claim 8, wherein the comparing is performed according to a set of comparison rules.

11. The system of claim 10, wherein the set of comparison rules comprises a first rule associated with a first field type of the target merchant listing and a second field type of the target merchant listing.

12. The system of claim 11, further comprising identifying the first data field of the first set of data fields of the published merchant listing is the first field type.

13. The system of claim 12, wherein the first data field of the published merchant listing is compared to the second data field of the target merchant listing in accordance with the first rule.

14. The system of claim 8, wherein the comparing is performed according to a machine learning process.

15. A non-transitory computer readable storage medium comprising instructions that, when executed by a processing device of a source system, cause the processing device to perform operations comprising:
scanning, by a processing device, a publisher system of a set of publisher systems to identify a published merchant listing associated with the publisher system, wherein the published merchant listing comprises a first set of data fields and a first set of data field values associated with a merchant system;
comparing, on a field-by-field basis, the published merchant system to a target merchant listing comprising a second set of data fields and a second set of data field values associated with the merchant system; and
identifying, based on the comparing, a discrepancy between a first data value of a first data field of the first set of data fields of the published merchant listing and a second data value of a second data field of the second set of data fields of the target merchant listing.

16. The non-transitory computer readable storage medium of claim 15, the operations further comprising causing generation of a graphical user interface comprising an indication of the discrepancy.

17. The non-transitory computer readable storage medium of claim 15, wherein the comparing is performed according to a set of comparison rules comprising a first rule associated with a first field type of the target merchant listing and a second field type of the target merchant listing.

18. The non-transitory computer readable storage medium of claim 17, the operations further comprising identifying the first data field of the first set of data fields of the published merchant listing is the first field type.

19. The non-transitory computer readable storage medium of claim 18, wherein the first data field of the published merchant listing is compared to the second data field of the target merchant listing in accordance with the first rule.

20. The non-transitory computer readable storage medium of claim 15, wherein the comparing is performed according to a machine learning process.
